(19) United States
(12) Patent Application Publication
(10) Pub. No.: US 2023/0222908 A1
(43) Pub. Date: Jul. 13, 2023

(54) ROADWAY INFORMATION DETECTION SYSTEM CONSISTS OF SENSORS ON THE AUTONOMOUS VEHICLES AND DEVICES FOR THE ROAD

(71) Applicants: Peter Yeung, Ottawa (CA); Kenneth Yeung, Ottawa (CA)

(72) Inventors: Peter Yeung, Ottawa (CA); Kenneth Yeung, Ottawa (CA)

(21) Appl. No.: 18/101,463

(22) Filed: Jan. 25, 2023

Related U.S. Application Data
(63) Continuation-in-part of application No. 17/350,155, filed on Jun. 17, 2021, now Pat. No. 11,600,178.
Application No. 17/350,155 is a continuation of application No. 16/245,503, filed on Jan. 11, 2019, now Pat. No. 11,043,124.
Application No. 16/245,503 is a continuation-in-part of application No. 17/553,660, filed on Dec. 16, 2021.
Application No. 17/553,660 is a continuation of application No. 15/784,168, filed on Oct. 15, 2017, now Pat. No. 11,237,011.
(60) Provisional application No. 62/624,385, filed on Jan. 31, 2018.

(30) Foreign Application Priority Data
Aug. 18, 2016 (CA) 2945564

(51) Int. Cl. G08G 1/0967; E01F 9/30; G06V 20/58; G05D 1/00; G08G 1/16

(52) U.S. Cl. CPC G08G 1/096725; E01F 9/30; G06V 20/582; G08G 1/096783; G05D 1/0088; G08G 1/166; G05D 2201/0213

(57) ABSTRACT

The present invention relates to the guidance of autonomous vehicles and in particular, relates to guiding an autonomous vehicle along a roadway by means of active devices with a system which works during normal and inclement, weather as well as under any luminous conditions, These active devices are embedded in the passive and/or active road details such as traffic signs, traffic lights, warning lights etc. These active devices provide data relating to road conditions, speed, road layout etc. as well as other information such as availability of parking spaces. Accordingly, through networks of sensors and devices the autonomous vehicle can obtain road details in real-time in any weather, illumination, visibility etc.

### CROSS-REFERENCE TO RELATED APPLICATIONS

This application claims the benefit of priority as a continuation-in-part patent application of U.S. patent application Ser. No. 17/350,155 filed Jun. 17, 2021; which itself claims the benefit of priority from U.S. patent application Ser. No. 16/245,503 filed Jan. 11, 2019 which has issued as U.S. Pat. No. 11,043,124; which itself claims the benefit of priority from U.S. Provisional Patent Application 62/624,385 filed Jan. 31, 2018; the entire contents of each being incorporated herein by reference.

This application claims the benefit of priority as a continuation-in-part patent application of U.S. patent application Ser. No. 17/553,660 filed Dec. 16, 2021; which itself claims the benefit of priority from U.S. patent application Ser. No. 15/784,168 filed Oct. 15, 2017 which has issued as U.S. Pat. No. 11,237,011;which itself claims the benefit of priority from Canadian Patent Application 2,945,564 filed Oct. 18, 2016.

### FIELD OF THE INVENTION

The present invention relates to the guidance of autonomous vehicles and in particular, relates to guiding an autonomous vehicle along a roadway by means of active devices [d1] during normal and inclement weather that will work under any luminous conditions.

### BACKGROUND OF THE INVENTION

The Proposed sensor devices are strategically placed in or on the vehicle that will detect active devices [d1]. The Devices [d1] could be self-powered by solar and/or batteries with active electronics to process approaching vehicles or/and pedestrians for where powers are not readily available. This self-contained or/and networked device[d1] will either receive a discovery signal from the approaching vehicle or self-detect the vehicle/pedestrian or even provided by the network. Once either vehicle or pedestrian is known then the device[d1] will either reply with the predetermined information to the vehicle or/and has already display the “status” (i.e.: stop sign) or/and it displays the information.

Currently, the autonomous vehicles are helpless and cannot or do not know the signs or road details without aid of camera system or detailed pre-mapped system of navigation. In use today, the navigation system is either GPS based for obtaining details of the roads or/and uses LiDAR, or/and optical (Camera) based for mapping of the road network sign(s) in conjunction with pre-mapped extremely detailed road information. This pre-mapping of the road is inefficient and, in most cases, impractical if there are continual changes to the roadways (especially with the rate of change ranging from daily to hourly). These constant changes can create havoc to autonomous vehicles on the road if they do not have the latest updates or if there are changes of the road networks. This could potentially result in a big catastrophe. Even if feasible, the amount of changes will require a multitude of road networks to be re-mapped. This will not give the autonomous vehicles the information it needs to navigate the roadway in a timely manner.

Furthermore, current technologies such as camera (optical), LiDAR, and other roadway interpretation systems fail under severe weather conditions and under certain luminous conditions. As such, the present invention claims will help evolve the self-driving, autonomous vehicles to navigate the road in a more effective manner under normal or severe weather condition and any luminous conditions.

Based on the preliminary research of the current technologies that are deployed or proposed to solve the navigation for the autonomous vehicles on our roads today, all fail to navigate under inclement weather conditions and are costly to implement. However, the present invention below represents a more economical and efficient way to implement a self-assisted navigation system. For example, one of the claims is to modify the existing passive signage(s) to an active device so that sensors on the autonomous vehicle can accurately pick up the information ahead before it traverse the road. These details of the road could be a simple stop sign(s) or parking spaces available ahead on the road and can be even adapted to provide information from pass stop to approaching autonomous bus—especially under (inclement weather and any luminous) conditions.

The proposed sensor devices are strategically placed in or on the vehicle that will detect “special” lane markers. The lane markers can consist of any of the following: reflective paints, metal paints, small sensors that light up (when the vehicle is about to approach the markers) whose power is from solar, battery, or by the vehicle itself sending microwave energy to activate these lane markers.

Currently autonomous vehicles are helpless without a system of navigation. In use today, the navigation system is either GPS based for obtaining details of the roads or LIDAR-based (Light Detection and Ranging) for mapping of the road networks. This pre-mapping of the road is inefficient and, in most cases, impractical if there are continual changes to the vehicles on the road if they do not have the latest updates or changes of the road networks. This could potentially result in a catastrophe. Even if feasible, the amount of changes will require a multitude of road networks to be re-mapped. This will not give the autonomous vehicles the information it needs to navigate the roadway in a timely manner.

Furthermore, current technologies such as optical systems, LIDAR, and other roadway interpretation systems fail under severe weather conditions and under certain luminous conditions. As such, the present invention claims will help evolve the self-driving, autonomous vehicles to navigate the road in a more effective manner under normal or severe weather conditions and any luminous conditions.

Based on the preliminary research of the current technologies that is deployed or proposed to solve the navigation for the autonomous vehicles on our roads today, all fail to navigate under inclement weather conditions and are costly to implement. However, the present invention below represents a more economical and efficient way to implement a self-assisted navigation system. For example, one of the claims is to modify the existing lane marking painting technique using ferrous or non-ferrous materials so that sensors on the autonomous vehicle can accurately pick up or sense the location of the marker(s) on the road—especially under inclement weather conditions.

As an example, in U.S. Pat. No. 9,080,866 B1 patent it claims that it's using a laser detection system to pick up reflections from the lane marker reflective property. Under inclement weather this system will fail as snow, ice, fog, or rain will cause havoc with a laser based detection system. The laser will not be able to penetrate heavy snow and may get a false reflection signal from bouncing off the snow.

In another example from patent US 2015/0303581A1, a reflector which contains both microwave retro-reflector and an embedded tuned circuit is claimed. This type of system tends to be expensive to implement as it requires installing active circuitry devices along the many miles of the road as lane markers. And not to mention these active devices could become malfunction or die altogether over time.

### SUMMARY OF THE INVENTION

This disclosure relates to an autonomous vehicle and a system for controlling the vehicle, more specifically, the present disclosure is directed towards autonomous vehicles with a plurality of sensor devices to read road information then to navigate along the roadway.

It is the objective of the present disclosure to provide an improved autonomous vehicle and a system of sensor devices for detecting the road information from passive signage(s)/traffic cone(s) which can be read/received when in severe weather conditions and/or luminous conditions.

According to an aspect of the disclosure it is to provide an autonomous vehicle, comprising:
A system of sensor devices strategically placed on an autonomous vehicle to read/receive road information whereby this information is then processed by a hub, then passed onto either an autonomous control system and/or 3D map navigation database system to decide on how to navigate the road safely in a real-time manner, the system comprises of:
   The hub includes processing and storage capability;
   Sensor devices on the vehicle consisting of components that will transmit a discovery signal, and received information from active devices on the roadway;
   Wherein the hub, once the roadway information is processed it is then communicated back to the autonomous control system and/or 3D map navigation database system where a roadway path is formulated for navigation; and
   Wherein road information is captured and mapped in real-time for use and updated to the network.

In another aspect of the disclosure it is to provide an autonomous vehicle comprising:
A non-transitory computer readable storage medium storing instructions for controlling a system of sensor devices strategically placed on an autonomous vehicle to read/receive road information whereby this information is then processed by a hub, then passed onto either an autonomous control system and/or 3D map navigation database system to decide on how to navigate the road safely in a real-time manner, the system comprises of:
   The hub includes processing and storage capability;
   Sensor devices consisting of components that will transmit a discovery signal, where the discovery signal will be transmitted from the vehicle to the active devices [d1] then the active devices either display or transmit it's information back to the vehicle or display it's information;
   Wherein the hub, once the roadway information is processed it is then communicated back to the autonomous control system and/or 3D map navigation database system where a roadway path is formulated for navigation; and
   Wherein road information is captured and mapped in real-time for use and updated to the network.

In another aspect of the disclosure it is to provide an autonomous vehicle comprising:
A method for sensor devices strategically placed on an autonomous vehicle to read road information whereby this information is then processed by a hub and then passed onto either an autonomous control system and/or 3D map navigation database system to decide on how to navigate the road safely in a real-time manner, the method comprises of: Providing the hub with processing and storage capability;
   Including sensor devices consisting of components that will transmit a discovery signal, where the discovery signal will be transmitted from the vehicle where devices on the roadway can be discovered through reply to the discovery signal or/and acquired by means of reading the display of the devices;
   Processing roadway information in the hub which is then communicated back to the autonomous control system and/or 3D map navigation database system, where a roadway path is formulated for navigation; and
   Capturing and mapping road information in real-time for use and updated to the network.

This disclosure relates to an autonomous vehicle and a system from controlling the same. More specifically, the present disclosure is directed towards autonomous vehicles with a plurality of sensor devices to read road information to navigate along the roadway.

It is the objective of the present disclosure to provide an improved autonomous vehicle and a system of sensor devices for detecting the road information from passive lane markers which can be read when in severe weather conditions and/or luminous conditions.

According to an aspect of the disclosure it is to provide an autonomous vehicle, comprising:
a system of sensor devices strategically placed on an autonomous vehicle to read road information whereby this information is then processed by a hub, then passed onto either an autonomous control system and/or 3D map navigation database system to decide on how to navigate the road safely in a real-time manner, the system comprises of: the hub includes processing and storage capability;
   sensor devices on the vehicle consisting of components that will transmit a discovery signal, and from which lane markers on the roadway can be discovered through signal processing of the reflected signals; wherein
the hub, once the roadway information is processed it is then communicated back to the autonomous control system and/or 3D map navigation database system where a roadway path is formulated for navigation; and
wherein road information is captured and mapped in real-time for use and updated to the network.

In another aspect of the disclosure it is to provide an autonomous vehicle comprising:
a non-transitory computer readable storage medium storing instructions for controlling a system of sensor devices strategically placed on an autonomous vehicle to read road information whereby this information is then processed by a hub, then passed onto either an autonomous control system and/or 3D map navigation database system to decide on how to navigate the road safely in a real-time manner, the system comprises of: the hub includes processing and storage capability;
   sensor devices consisting of components that will transmit a discovery signal, where the discovery signal will be transmitted from the vehicle where lane markers on the roadway can be discovered through signal processing of the reflected signals;
wherein the hub, once the roadway information is processed it is then communicated back to the autonomous control system and/or 3D map navigation database system where a roadway path is formulated for navigation; and
wherein road information is captured and mapped in real-time for use and updated to the network.

In another aspect of the disclosure it is to provide an autonomous vehicle comprising:
a method for sensor devices strategically placed on an autonomous vehicle to read road information whereby this information is then processed by a hub and then passed onto either an autonomous control system and/or 3D map navigation database system to decide on how to navigate the road safely in a real-time manner, the method comprises of: providing the hub with processing and storage capability;
   including sensor devices consisting of components that will transmit a discovery signal, where the discovery signal will be transmitted from the vehicle where lane markers on the roadway can be discovered through signal processing of the reflected signals;
   processing roadway information in the hub which is then communicated back to the autonomous control system and/or 3D map navigation database system, where a roadway path is formulated for navigation; and
   capturing and mapping road information in real-time for use and updated to the network.

Additional objects, features and advantages of the present invention will become more readily apparent from the following embodiments when taken in conjunction with the drawings wherein the reference numerals refer to the corresponding parts in the several views.

### BRIEF DESCRIPTION OF THE DRAWINGS

The description herein makes reference to the accompanying drawings below wherein like reference numerals refer to like parts throughout the several views, and wherein:

FIG. 1 depicts a scenario for autonomous vehicle on a roadway representing the various devices [d1] that an autonomous vehicle may encounter in a scenario. Each of the red box representing devices [d1] such as the one directional sign, or the no entry sign, traffic signal lights, person walking on the street, to the person riding a bicycle on the roadways and other cars can be view as devices. Where the autonomous vehicle is represented by the red dot on roof of the vehicle are sensor(s). The sensor(s) may be strategically place on the vehicle and may not be necessary on the roof top.

FIG. 2 depicts a discovery signal are sent out by the autonomous vehicle, illustrates how the sensors will pick up the signal from the devices around the autonomous vehicle with discovery signal being sent out. Either by active reply or reflected signal from the devices.

FIG. 3 depicts various road signs/cone and other passive indicators. All the passive device(s) signs, cones and other devices are deployed today and in the future can be converted and/or co-exist with the into the embodiment of the invention. These are some of the sample of the roads signs/cones/bus stop that can be converted from passive to active devices that will allow the autonomous vehicle to be aware of while it is travelling the roadway network to a destination.

FIG. 4 depicts an example of stop signs being converted from passive to active devices it illustrates a stop sign that can be converted from passive device to active devices with powered active electronics powered by solar arrays and/or batteries. There could be a combination power sources that power this device. In this figure, we have 1. Solar array—collects power from sun light; either is fed directly to the active electronic or via battery. 2. Various sizes or shape of the current passive or/and active information display. 3. Various degrees of movement the solar array can be set to best collect sun energy. 4. Pivot point holding the solar array and/or various sensors and/or antenna. Can be place anywhere that is best to collect maximum power or best reception or transmission. 5. This represents the active electronic housing. 6. A post that is placed on the ground to hold the devices. This is only a representation of device as a sign(s). The device can also be a parking space indicator/information system for the autonomous vehicle where the parking spaces are free or occupied within the roadway. Where there are sensor that will detect if there is a vehicle occupying the space or not. Or traffic lights, pedestrian, traffic light(s). The holy grail of this invention is a roadside information (device) active or passive being alerted by the autonomous vehicle (sensor) in real time and in any weather or luminous conditions.

FIG. 5 is a block diagram of the sensor strategically mounted on the vehicle (in this case at the front) pointing down towards the road. Also shown is the RF transmitted wave impinging on the lane markers (installed along the roadway) and being reflected back towards the sensor antenna. This reflected signal is used by the central processing hub and autonomous control system for further processing and mapping of the roadway for navigation.

FIG. 6 illustrates how the sensors not only require to detect the lane markers immediately adjacent to the vehicle, but they also need to detect the lane markers that are either one or multiple lane(s) over from the current lane that the vehicle is on.

FIG. 7 is a block diagram illustrating the systems embodiment of the invention.

FIG. 8 is a block diagram showing 4 antennas strategically placed on the vehicle to cover all 4 sides of the vehicle while pointing down towards the road—the diagram illustrates along a straight road. Each antenna will have a certain beamwidth θ (in degrees) to encompass the side of the vehicle it is intended for and to ensure sufficient coverage overlap to pick up most of the lane markers for proper & accurate mapping of the roadway.

Devices (could have all the below components or part of it and other future components that are not identified below. It depends on the application):

Electronics
Active Network Connection
   Wired
   Wireless
Power Source
   Batteries
   Solar panel
   On site electrical power from utilities grid
   Temporary power from autonomous vehicles
Camera or RF technology
Receiver(s)
Transmitter(s)
Antenna(s)
Sensors for various application (i.e. infra-red, audio and etc.)
Push button
GPS capabilities
Sound Generating device(s)
All Weather and All Tempering proofing
May have active electronic/static display to pedestrians or visual aid for autonomous vehicles.

### DETAILED DESCRIPTION

The embedded devices [d1] are either powered up by itself by itself solar or small long-lasting batteries or a combination of all of above and/or can be powered by the car by sending energy sources such as microwaves and etc. The sign information is transmitted back to the approaching vehicles by a common frequency that all autonomous vehicles understand and can interpret and process. Both the sign and the autonomous vehicle sensors and devices can potentially work on a dedicated short-range communication (DSRC) but not limited to DSRC. DSRC works in 5.9 GHz band with bandwidth of 75 MHz and approximate range of 1000 m. Vehicular sensors[s2] and road network devices[D1]

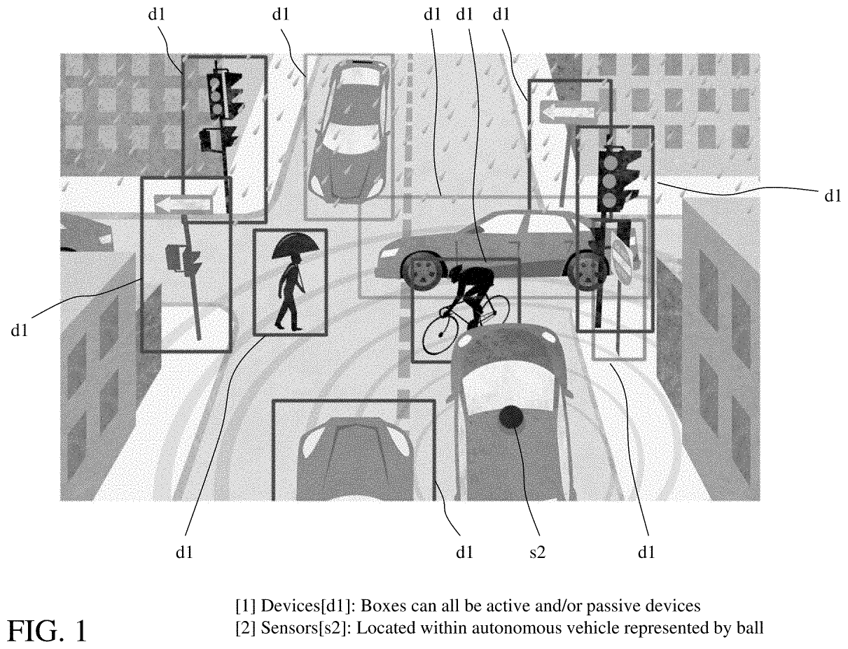

FIG. 1 demonstrates a scenario where the RF transmits energy from red dot on the vehicle rooftop to the surrounding area to discover the create a map of the roadway and objects around itself. Where the active devices are actively listening to this signal they will either reply or display the information for the vehicle. The sensor can either be a complete unit system with an integrated sectorized antenna (a ruggedized design suitable for withstanding severe weather condition while strategically placed on the inside or outside of the vehicle), or it can simply be the sensor installed inside the vehicle (1) while a ruggedized, sectorized antenna (connected to the sensor via a RF cable) is strategically mounted on the vehicle exterior.

Based on the information read or received, a detail of the environment could be gathered. In order to have sufficient data points to formulate detail of the devices or objects of the roadway, the transmitted signal needs multitudes of samples per second.

Note in order to cover the front, back, and sides of the vehicle, multiple sensors (and their associated antennas) maybe required to be installed. The number of sensors required is dictated by the achievable data point resolution to accurately generate a 3-D map of the road. As such, the sensor antenna coverage beamwidth and gain (to resolve and coherently receive the reflected signal) performance will contribute to the number of sensors required.

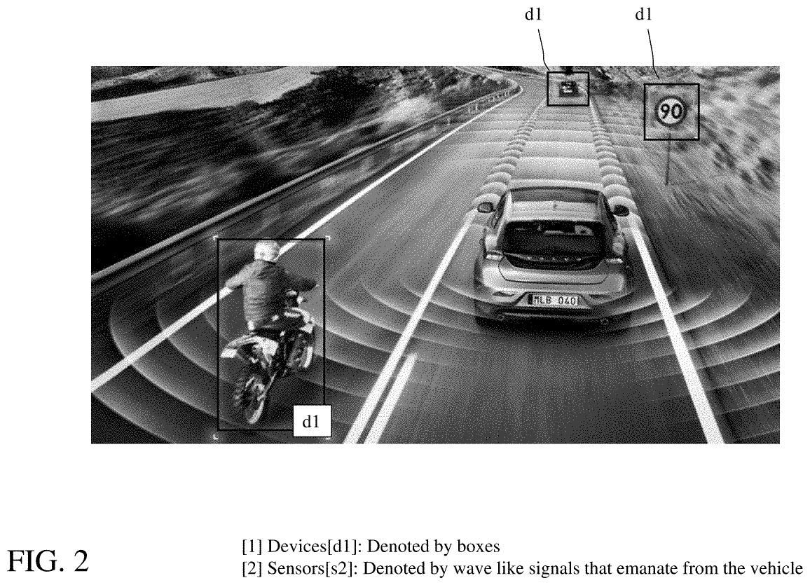

FIG. 2 illustrates how the sensors has to continually send out discovery signals as it traverses the road, so that it has total awareness of the device (objects) of the road it is travelling on in order to make a sound and safe decision in real time. The constant changes in the road information will need to be fed to the vehicle or actively seek for it.

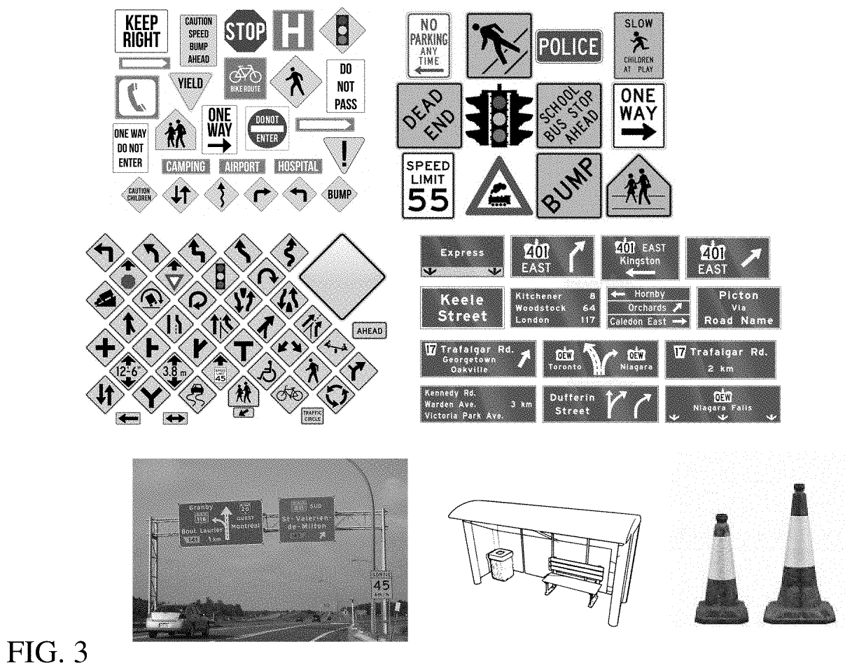

FIG. 3 is the embodiment of the invention. This is a representation of a static sign being converted or co-existing with the active electronic that provide the information to travelling autonomous vehicle(s). This also can be adapted to inform the autonomous autobus that there are passenger waiting at the bus stop.

Once the information is processed and the information is parsed and identified then it is sent to the Autonomous Control System (ACS) and/or the 3D map navigation database system. Below briefly explains the function of each entity and how each interacts with one another.

The sensor sends out the discovery signal from the autonomous vehicle to discover the all the devices on the road as it travel.

All the received data from the sensors are processed by the hub. The main goal of the system is to identify all the device(s) on the road that are within certain distance from itself. After the device(s) are identified and processed, this information is passed to the Autonomous Control System and/or the 3D map navigation system. This has to happen in real time and in advance of the path the vehicle is traveling on.

The 3D map navigation database system, where the road networks are detailed and created into three dimensional images so that the autonomous vehicle can use to traverse to its destination or simply find a suitable parking space. In the scenario where the autonomous vehicle relies on using the 3D detailed mapping database system to obtain the devices on the road as it is traveling, then the proposed system will compare the device(s) information on the 3D map to see if it is up to date with the newly acquired information. In the event there are discrepancies and devices are permanently in nature, the system thus flags the changes for the 3D mapping system to make the updated changes. In the event the device(s) are temporary like traffic cones, then the system utilized this real-time information to navigate.

In a scenario where the autonomous vehicle is acquiring the road information in real time, the identified device(s) information is passed directly to the Autonomous Control System (ACS) for use in navigating the roadway. Once the autonomous vehicle has successfully navigated the roadway, then this information is passed to the 3D mapping system to compare and update the information for future use via locally stored or, via other 3D mapping systems on the network.

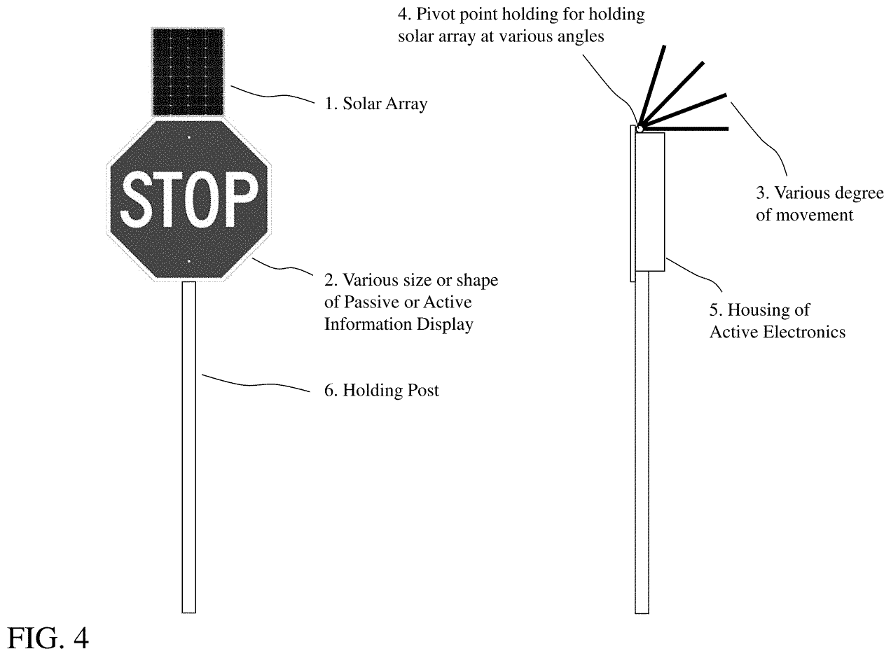

FIG. 4 sample of stop signs being converted from passive to active devices it illustrates a stop sign that can be converted from passive device to active devices with powered active electronics powered by solar array and/or battery. There could be a combination of solar and constant reliable power, powering this active device. In this figure, we have 1. Solar array—collect power from sun light, either is fed directly to the active electronic or via battery. 2. Various sizes or shapes of the current passive or/and active information display. 3. Various degrees of movement that the solar array can be set to best collect sun energy. 4. Pivot point holding the solar array and/or various sensors and/or antenna. 5. This represents the active electronic housing. 6. A post that is placed on the ground to hold the devices. This is only a representation of device as a sign(s). The device can also be a parking space indicator/information system for the autonomous vehicle where the parking spaces are free or occupied within the roadway, where there are sensor that will detect if there is a vehicle occupying the space or not. Or traffic lights, pedestrian, traffic light(s). The holy grail of this invention is a roadside information (device) that is active or passive alerting the autonomous vehicle (sensor) in real time and in any weather or luminous conditions.

As all the device(s) are learnt from all sides of the vehicle, this information can be stored in a 3D map navigation database, or the autonomous control system depending on which database is being used. Further, with the mapping the vehicle can update the mapping process for other vehicles in real time if there have been changes to the road due to construction or other such adjustments.

Based on the above, in the referred embodiment depicted, the system will work even under severe adverse weather conditions. The active sensor devices in the autonomous vehicle continue to read the device(s) on the roadway information at certain frequency intervals in real-time. The sensor in the autonomous vehicle can function independently as a stand-alone system or in conjunction with other existing navigation system (such as the GPS or Lidar systems for example) to give it finer details of the roadway that it is travelling on. The proposed system is superior to other existing systems because, unlike other existing systems, this system will continue to work autonomously even under severe weather conditions such as heavy snowstorm, ice, fog or any other inclement weather.

It is important for the autonomous vehicle to have the latest road network details to navigate. These sensors can be strategically placed in, or mounted on, the vehicle to enable them to read the most accurate road information for either a straight or bent road.

Note that the proposed system does not require modification to the existing road networks, with the exception of changing or installing co-exiting active electronics. Thus, to summarize, the following is a sequence of steps that must happen for the autonomous vehicle to navigate the roadway in the most effective manner:
1. The sensor would send a discovery signal ahead using sonar like technology for example.
2. The roadside device(s) either send a reply or display information back to the source.
3. The sensor in the vehicle receives the discovered information signal and passes it on to the processing hub.
4. The hub interprets/processes the information as it receives it in real time.
5. The processed information is translated to a format that is consumable by the autonomous control system or 3D map navigation database system.
6. The autonomous control system or 3D map navigation database system processes the information and makes decision based on the received discovered signals from the proposed device(s).

In order to have the most effective and accurate road information, the sensors would read the information from ahead and from both sides of the vehicle to determine the roadway structures and objects. Each side of the road may provide different information as the vehicle travels ahead. Once the information is obtained by the autonomous control system and/or 3D map navigation database system, it then processes it and formulates a decision on how to best navigate. The proposed system will work under any weather condition.

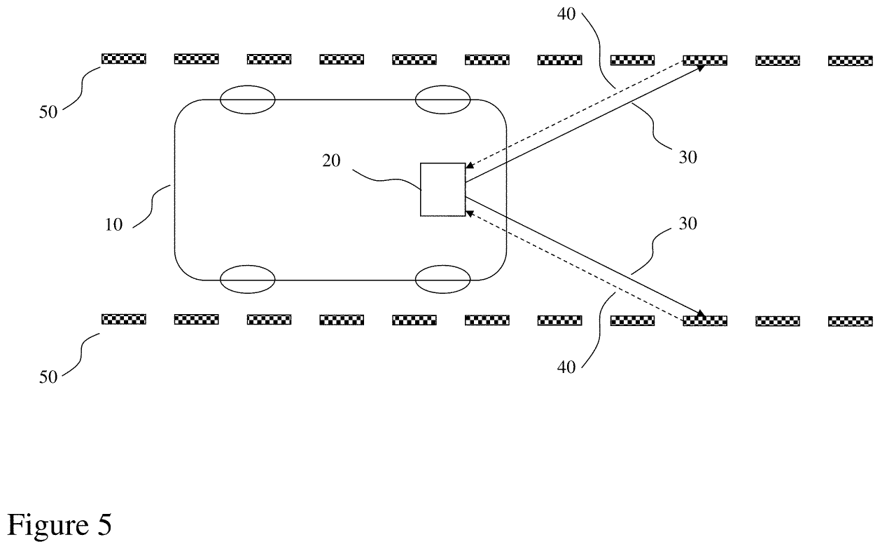

FIG. 5 demonstrates a scenario where the RF transmitted signal 30 from the vehicle rooftop sensor 20 is incident upon the lane marker(s) 50 and bounces back towards the sensor. The sensor can either be a complete unit system with an integrated sectorized antenna (a ruggedized design suitable for withstanding severe weather condition while strategically placed on the inside or outside of the vehicle), or it can simply be the sensor installed inside the vehicle 10 while a ruggedized, sectorized antenna (connected to the sensor via a RF cable) is strategically mounted on the vehicle exterior.

Based on the time of arrival and incident angle of the reflected signal 40, the distance between the vehicle and the lane marker(s) 50 can be calculated. In order to have sufficient data points to formulate a mapping of the roadway, the transmitted signal 30 is required to be sent out frequently at multiple samples per second.

Note in order to cover the front, back, and sides of the vehicle, multiple sensors (and their associated antennas) will be required to be installed. The number of sensors required is dictated by the achievable data point resolution to accurately generate a 3-D map of the road. As such, the sensor antenna coverage beamwidth and gain (to resolve and coherently receive the reflected signal) performance will contribute to the number of sensors required.

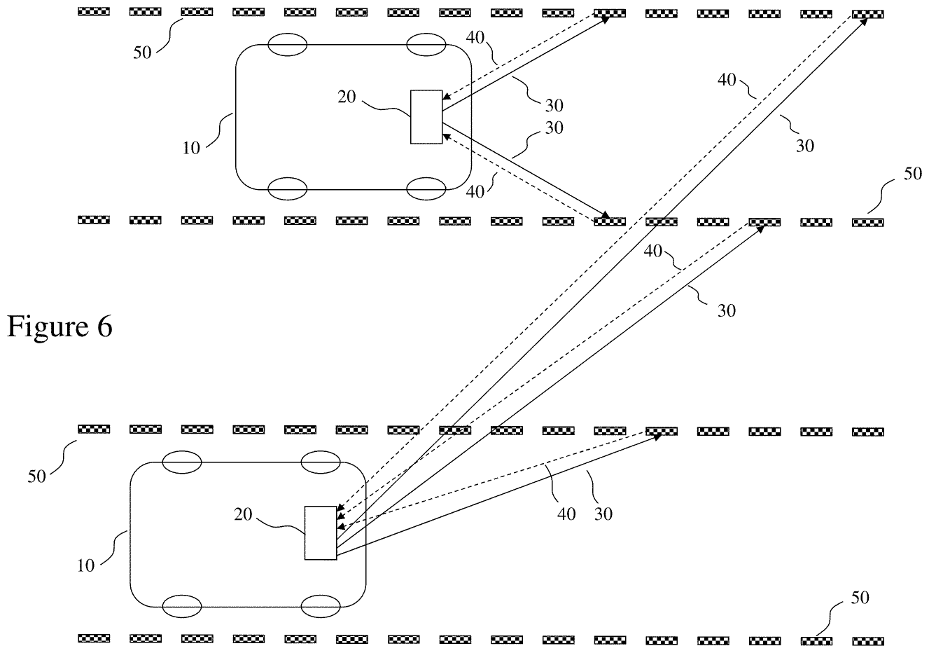

FIG. 6 illustrates how the sensors not only require to detect the lane markers 50 immediately adjacent to the vehicle, but they also need to detect the lane markers 50 that are one or multiple lane(s) over from the current lane that the vehicle is on. Although FIG. 6 only shows the one lane over to the left of the current lane (that the vehicle is on), the same scenario or concept applies to the lane over to the right of the current lane. And similar to FIG. 5, the front, back, and sides of the vehicle must be accounted for by the sensors. This is necessary for making proper lane changes.

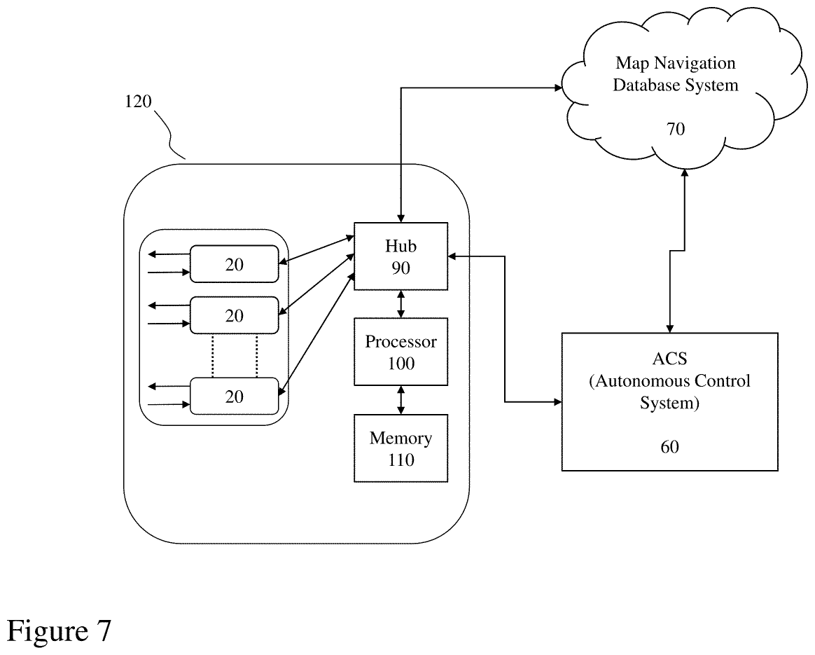

The circle 120 in FIG. 7 is the embodiment of the invention. In the circle 120, we have the sensors 20, hub 90, processor 100 and memory 110 where the roadway information is acquired, identified and processed. Once the information is processed and the information parsed and identified then it is sent to the Autonomous Control System (ACS) 60 and/or the 3D map navigation database system 70. Below briefly explains the function of each entity and how each interacts with one another.

The sensor sends out the discovery signal from the autonomous vehicle to discover the lane marker(s) 50 as explained in FIG. 5 above.

All the received data from the sensors are processed by the hub. The main goal of the system is to identify the lane markers 50. After the lane markers 50 are identified and processed, this information is passed to the Autonomous Control System and/or the 3D map navigation system. This has to happen in real time and in advance of the path the vehicle is traveling on.

The 3D map navigation database system, where the road networks are detailed and created into three dimensional so that the autonomous vehicle can use to traverse to its destination. In the scenario where the autonomous vehicle relies on using the 3D detailed mapping database system to obtain the lane information as it is traveling, then the proposed system in the circle 12 will compare the lane marking information on the 3D map to see if it is up to date with the newly acquired information. In the event the lane markers 50 are out of date, the system thus flags the changes for the 3D mapping system to make the updated changes.

In a scenario where the autonomous vehicle is acquiring the road information in real time, the identified lane marker 50 information is passed directly to the Autonomous Control System (ACS) for use in navigating the roadway. Once the autonomous vehicle has successfully navigated the roadway, then this information is passed to the 3D mapping system to compare and update lanes marking information for future use via locally stored or, via other 3D mapping system on the network.

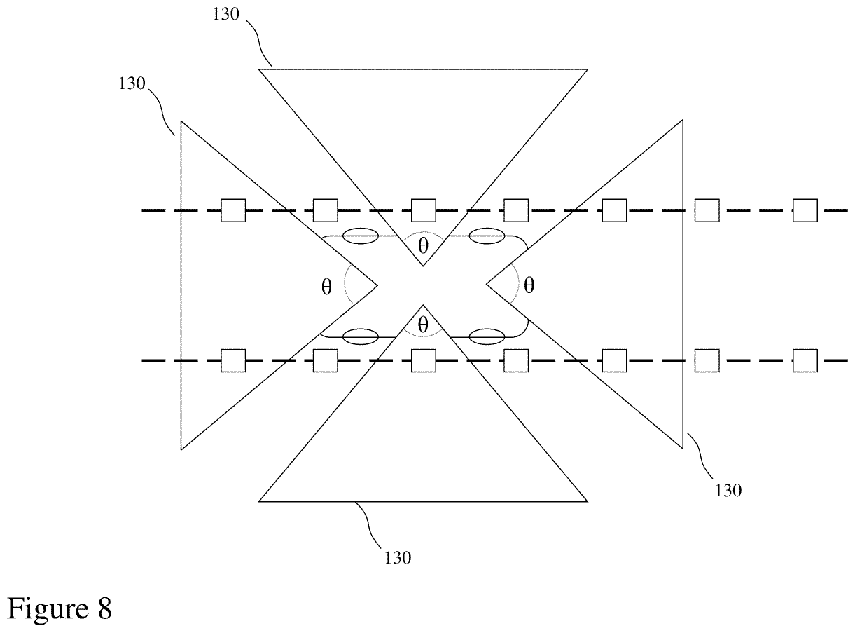

FIG. 8 shows the coverage angle of each transmitted beam from the autonomous vehicle to the lane markers 50 for all sides 130. The reflected signal from the passive lane markers 50 is processed, and from this the relative distance of each lane marker 50 to the vehicle is determined. The sensors send out discovery signals to find out the lane markers 50 from all sides of the vehicle to indicate that the vehicle is within the corresponding lane markers 50. As the lane markers 50 are learnt then adjustments are made through the autonomous control system and may involve reducing the speed of the vehicle.

In the event the vehicle is required to go in the reverse direction it would have all the needed information to complete its task.

As all the lane markers 50 are learnt from all sides of the vehicle, this information can be stored in a 3D map navigation database, or the autonomous control system depending on which database is being used. Further, with the mapping the vehicle can update the mapping process for other vehicles in real time if there have been changes to the road due to construction or other such adjustments.

Based on the above, in the referred embodiment depicted, the system will work even under severe adverse weather conditions. The active sensor devices in the autonomous vehicle continue to read the lane and roadway information at certain frequency interval in real-time. The sensor devices in the autonomous vehicle can function independently as a stand-alone system or in conjunction with other existing navigation system (such as the GPS or Lidar system for example) to give it finer details of the roadway that it is travelling on. The proposed system is superior to other existing systems because, unlike other existing systems, this system will continue to work autonomously even under severe weather conditions such as heavy snowstorm, ice, fog or any other inclement weather.

It is important for the autonomous vehicle to have the latest road network details to navigate. These sensor devices can be strategically placed in, or mounted on, the vehicle to enable them to read the most accurate road information for either a straight or bent road.

Note that the proposed system does not require modification to the existing road networks, with the exception of changing the paint based material used for painting the lane lines/markers 50. As well, the lane markers 50 could also be made of metallic lane markers 50. Thus, to summarize, the following is a sequence of steps that must happen for the autonomous vehicle to navigate the roadway in the most effective manner:

1. The sensor devices would send a discovery signal ahead using sonar technology for example.

2. The metallic paints or metallic lane markers 50 bounces the discovered information back to the source.

3. The sensor device in the vehicle receives the discovered information signal (bounced off the lane markers 50) and passes it on to the processing hub.

4. The hub interprets/processes the information as it receives it in real time.

5. The processed information is translated to a format that is consumable by the autonomous control system or 3D map navigation database system.

6. The autonomous control system or 3D map navigation database system processes the information and makes decision based on the received discovered signals from the proposed sensor devices.

In order to have the most effective and accurate road information, the sensors would read the information from ahead and from both sides of the vehicle to determine the lane structures. Each side of the road may provide different information as the vehicle travels ahead. Once the information is obtained by the autonomous control system and/or 3D map navigation database system, it then processes it and formulates a decision on how to best navigate. The proposed system will work under any weather condition.

Although described with reference to referred embodiments of the invention, it should be readily understood that various changes and/or modifications can be made to the invention without departing from the spirit thereof. In general, the invention is only intended to be limited by the scope of the following claims.

Thus, the following outlines a set of claims that will help or evolve the self-driving, autonomous vehicles to navigate the road in a more effective manner under normal or sever weather and luminous condition:

What is claimed is:

1. A method comprising:
providing a plurality of devices deployed with respect to a section of roadway where a first subset of the plurality of devices are active devices and a second subset of the plurality of devices are passive devices;
transmitting a plurality of response signals where each response signal is transmitted by a first transmitter operating according to a predetermined wireless protocol forming part of an active device of the plurality of devices associated with a predetermined element of the section of roadway and was generated by a first microprocessor forming part of each active device of the plurality of active devices in dependence upon receipt of a discovery signal by a first receiver operating according to the predetermined wireless protocol forming part of the active device of the plurality of devices associated with the predetermined element of the section of roadway received from a vehicle upon the section of roadway;
transmitting a plurality of reflected portions of the discovery signal where each reflected portion of the discovery signal was generated by a passive device of the plurality of devices associated with another predetermined element of the section of roadway reflecting a portion of the discovery signal; and
at least one controlling an aspect of the vehicle upon the section of roadway and navigating the vehicle upon the section of roadway in dependence upon the vehicle processing the plurality of response signals and the plurality of reflected portions of the discovery signal; wherein
each first microprocessor executes a first process comprising the steps of:
receiving the discovery signal;
compiling data for transmission in dependence upon the predetermined element of the section of roadway with which the active device of the plurality of active devices comprising the first microprocessor is associated; and
transmitting the compiled data as the response signal of the plurality of response signals from the active device of the plurality of active devices comprising the first microprocessor.

2. The method according to claim 1, further comprising
receiving the plurality of response signals and the plurality of reflected portions of the discovery signal with a second transceiver operating according to the predetermined wireless protocol forming part of the vehicle; and
processing the received plurality of response signals and the plurality of reflected portions of the discovery signal with a second microprocessor forming part of the vehicle to extract information and pass the information to a control system of the vehicle to control the aspect of the vehicle.

3. The method according to claim 1, further comprising
receiving the plurality of response signals and the plurality of reflected portions of the discovery signal with a second transceiver operating according to the predetermined wireless protocol forming part of the vehicle; and
processing the received plurality of response signals and the plurality of reflected portions of the discovery signal with a second microprocessor forming part of the vehicle to extract information and pass the information to a navigation system of the vehicle to navigate the vehicle.

4. The method according to claim 1, further comprising
receiving the plurality of response signals and the plurality of reflected portions of the discovery signal with a second transceiver operating according to the predetermined wireless protocol forming part of the vehicle;
processing the received plurality of response signals and the plurality of reflected portions of the discovery signal with a second microprocessor forming part of the vehicle to extract first information and pass the first information to a control system of the vehicle to control the aspect of the vehicle; and
processing the received plurality of response signals and the plurality of reflected portions of the discovery signal with a second microprocessor forming part of the vehicle to extract second information and pass the second information to a navigation system of the vehicle to navigate the vehicle.

5. The method according to claim 1, wherein
the vehicle is an autonomous vehicle.

6. The method according to claim 1, wherein
the vehicle is an autonomous vehicle.

7. The method according to claim 1, wherein
each the predetermined element of the section of roadway with which an active device of the plurality of devices is associated is selected from the group comprising a traffic light, a traffic sign, a parking sign, a traffic cone, and a bus stop.

8. The method according to claim 1, wherein
each the predetermined element of the section of roadway with which an active device of the plurality of devices is associated with is an element of the physical structure of the section of roadway itself.

9. The method according to claim 1, wherein
each predetermined element of the section of roadway with which an active device of the plurality of devices is associated with is another vehicle and a pedestrian.

10. The method according to claim 1, wherein
each another predetermined element of the section of roadway with which a passive device of the plurality of devices is associated with is selected from the group comprising a traffic light, a traffic sign, a parking sign, a traffic cone, a bus stop.

11. The method according to claim 1, wherein
each another predetermined element of the section of roadway with which a passive device of the plurality of devices is associated with is an element of the physical structure of the section of roadway itself or a lane marker of the section of roadway.

12. The method according to claim 1, wherein
each another the predetermined element of the section of roadway with which a passive device of the plurality of devices is associated with is a lane marker for the section of roadway.

13. The method according to claim 1, wherein
each predetermined element of the section of roadway with which an active device of the plurality of devices is associated with is an element of the physical structure of the section of roadway itself; and
each another predetermined element of the section of roadway with which a passive device of the plurality of devices is associated with is a lane marker for the section of roadway.

14. The method according to claim 1, wherein
the discovery signal, each response signal of the plurality of response signals from the active devices of the plurality of devices, and the plurality of reflected portions of the discovery signal from the passive devices of the plurality of devices provide communications with the vehicle from the plurality of devices during severe weather conditions selected from the group comprising a snowstorm, ice, and fog.

15. The method according to claim 1, wherein
the at least one controlling an aspect of the vehicle upon the section of roadway and navigating the vehicle upon the section of roadway are maintained under severe weather conditions selected from the group comprising a snowstorm, ice, and fog through the plurality of response signals and the plurality of reflected portions of the discovery signal received by the vehicle.

16. The method according to claim 1, wherein
the at least one controlling an aspect of the vehicle upon the section of roadway and navigating the vehicle upon the section of roadway in dependence upon the vehicle processing the plurality of response signals and the plurality of reflected portions of the discovery signal comprising an initial step of filtering the plurality of response signals and the plurality of reflected portions of the discovery signal in dependence upon a current direction of travel of the vehicle.

17. The method according to claim 1, wherein
each passive device of the plurality of devices is a passive road marker of a plurality of road markers;
each road marker of the plurality of road markers is in a predetermined spatial relationship to the remainder of the plurality of road markers

18. The method according to claim 17, wherein
each road marker of the plurality of passive road markers comprises one of:
one or more metallic elements; and
metallic paint.

19. The method according to claim 17, wherein
each passive road marker of the plurality of passive road markers comprises a paint based material comprising metallic elements;
the metallic elements reflect the RF signals from the one or more RF transmitters; and
the paint based material allows a user of a non-autonomous vehicle to navigate the non-autonomous vehicle upon the surface.

20. The method according to claim 17, wherein
the plurality of passive lane markers define a current lane the vehicle is currently travelling within and one or more lanes that are at least one of adjacent to the current lane in a first direction and adjacent to the current lane in a second direction.
